(19) United States
(12) Patent Application Publication
(10) Pub. No.: US 2020/0075969 A1
(43) Pub. Date: Mar. 5, 2020

(54) REDOX-FLOW ELECTROCHEMICAL CELL WITH DECREASED SHUNT

(71) Applicant: KEMIWATT, RENNES (FR)

(72) Inventors: Florent BEILLE, RENNES (FR); Jérémy ALLIX, RENNES (FR)

(21) Appl. No.: 16/463,924

(22) PCT Filed: Nov. 22, 2017
(86) PCT No.: PCT/EP2017/080118

§ 371 Date: May 24, 2019

(30) Foreign Application Priority Data
Nov. 28, 2016 (FR) 1661570

(51) Int. Cl. H01M 8/0273; H01M 8/18; H01M 8/04186

(52) U.S. Cl. CPC H01M 8/0273; H01M 8/04186; H01M 8/188

(57) ABSTRACT

An electrochemical cell including a frame of a porous electrochemical-cell electrode, the frame including a proximal portion close to a membrane, and a distal portion distant from the membrane; the frame includes a supply channel for supplying an electrochemical fluid and an inlet channel for a fluid supplying a lateral face of the electrode, the inlet channel including an orifice in the distal portion opening onto a lateral face of the electrode; the frame includes a discharge channel for discharging an electrochemical fluid and an outlet channel through which the fluid exits via a lateral face of the electrode, the outlet channel including an orifice in the distal portion opening onto a lateral face of the electrode; at least one of the inlet channel and outlet channel includes an orifice opening onto a supply channel or discharge channel in the proximal portion of the frame.

### FIELD OF THE INVENTION

The present invention relates to the field of electrochemical cells comprising electrodes separated by a membrane. The invention in particular relates to redox-flow electrochemical cells. The present invention also relates to a stack of electrochemical cells, a method for making electrochemical cells, and a method for producing current.

### PRIOR ART

In the field of the invention, a stack refers to a stack of electrochemical cells typically comprising the stack of at least two electrochemical cell electrodes generally kept compressed with one another, and separated from one another by a permeable ion exchange membrane, of at least two frames, each housing an electrode of an electrochemical cell and providing the sealing, supply and distribution of electrochemical fluids in the electrochemical cell. The stack also comprises two collector plates providing the supply and collection of electric current.

The frames of the stack must provide the sealing. This sealing is traditionally done by seals housed in housings of the frames dedicated to that purpose. The frames also provide the fluid supply of the cells using channels. This electrochemical flow supply must be as homogeneous as possible in order to provide the greatest possible planar operating homogeneity.

In general, the electrochemical cells comprising an ion exchange membrane are separated sealably into two zones, one making up an anode compartment and the other a cathode compartment separated by the ion exchange membrane. The inner sealing of the electrochemical cell is an essential issue for the proper working of the cell.

A stack generally has a flow of electrochemical fluid in parallel and an electrical stack of electrochemical cells in series. For the cells connected in series, a shunt current phenomenon may appear. This shunt current is due to an electrical circulation along the electrochemical fluids, in particular including electrolytes due to the fact that the cells are fluidly connected in parallel. Thus, the current will circulate along the fluid currents rather than through the electrochemical cells, causing a loss of efficiency.

To date, the players in this technical field have proposed different solutions by developing their own technology seeking to best meet its specific constraints, but without seeking to provide an electrochemical cell at once having good fluid sealing, homogeneous electrolyte distribution and a decreased shunt current.

U.S. Pat. No. 8,137,831 in particular exists, which relates to flow-type batteries, but the very specific configuration of this patent involves the use of electrolytes of the metal-halide type and considers limiting the shunt current by forcing the flow of electrolytes to pass through the porous electrode. In this configuration, the electrolyte flow supplies the upper surface of the porous electrode and does not teach how to resolve the technical problems raised by the present invention. The supply of the electrochemical fluid is done in this patent by two channels, one main, the other forming a bypass.

In a stack of redox-flow cells where the cells are fluidly in parallel and therefore all connected to one another by the electrolytes, if nothing is provided, the difference in potential between the cells combined with conductive electrolytes leads to the formation of shunt currents between cells, which on the one hand decreases the efficiency of the stack and on the other hand leads to undesirable reactions, such as the electrolysis of the water, rather than the targeted redox reaction. One simple solution could consist of electrically isolating the conductive zones in contact from the electrolytes outside the active surface. While it is easy to isolate a given surface from the collector plates for example using isolating polymer film or using an isolating coating or paint, it is more difficult to isolate the edge of the collector plates, which are typically from 0.5 to 1 mm thick. Moreover, adding an isolating film or a nonconductive coating adds an excess cost to the production of the cell and may pose the problem of lifetime in the case of a coating. One example is U.S. Pat. No. 4,371,433. Furthermore, electrically isolating the conductive zones does not suffice to sufficiently limit the shunt current.

Patent US 2015/0180074 considers elongating the fluid path by a U-shaped channel.

### Aims of the Invention

The present invention aims to provide an electrochemical cell making it possible to reduce shunt currents, in particular in electrochemical cells mounted fluidly in parallel.

The present invention aims to provide an electrochemical cell having a good lifetime.

The present invention aims to provide an electrochemical cell providing good sealing, in particular at the ion exchange membrane. This sealing is in fact crucial for the operation of an electrochemical battery, since an internal leak would cause mixing of the electrolytes and a rapid and irreversible loss of its capacity. The present invention aims to avoid these drawbacks.

The present invention aims to provide an electrochemical cell having a homogeneous distribution of electrochemical fluids.

The present invention also aims to provide an electrochemical cell that is easy to assemble and/or disassemble.

The present invention also aims to limit the production costs of a stack of electrochemical cells, in particular in the field of redox-flow electrochemical cells.

The complexity of these technical problems is in particular related to being capable of resolving all of them together, which the present invention proposes to resolve.

The present invention aims to resolve all of these technical problems reliably, industrially and at a low cost.

### DESCRIPTION OF THE INVENTION

To resolve the technical problems, the invention relates to a frame of a porous electrochemical cell electrode, said electrode being intended to make contact with a membrane.

The description is done in reference to the figures purely as an illustration, which cannot limit the scope of the invention.

The invention in particular relates to a frame 10, 50 of a porous electrochemical cell electrode 20, 30, said electrode being intended to make contact with a permeable ion exchange membrane 40, in which:
the frame 10, 50 comprises a proximal portion 14, 54 close to a membrane 40, and a distal portion 12, 52 distant from the membrane 40,
the frame 10, 50 comprises a supply channel 65, 66 for supplying an electrochemical fluid and an inlet channel 60, 61 for a fluid supplying a lateral face of the electrode 20, 30, the inlet channel 60, 61 comprising an orifice 62, 63 in the distal portion 12, 52 opening onto a lateral face of the electrode 20, 30,
the frame 10, 50 comprises a discharge channel 85, 86 for discharging an electrochemical fluid and an outlet channel 80, 81 through which the fluid exits via a lateral face of the electrode 20, 30, the outlet channel 80, 81 comprising an orifice 82, 83 in the distal portion 12, 52 opening onto a lateral face of the electrode 20, 30,
at least one, and preferably both, of the inlet channel 60, 61 and outlet channel 80, 81 comprises an inlet orifice 64, 67 or outlet orifice 84, 87, respectively, opening onto a supply channel 65, 66 or discharge channel 85, 86, respectively, in the proximal portion 14, 54 of the frame 10.

The invention also relates to an electrochemical cell, and in particular a redox-flow electrochemical cell 1, comprising at least one frame as previously defined, said cell comprising an upper frame 10 housing a first electrode 20 and a lower frame 50 housing a second electrode 30, the first electrode 20 and the second electrode 30 being separated from one another by a membrane 40, the first electrode 20 facing the membrane 40 by its lower face and the second electrode 30 facing the membrane 40 by its upper face, the upper frame 10 comprising a proximal portion 14 of the membrane 40 and a distal portion 12 of the membrane 40, the lower frame 50 comprising a proximal portion 54 of the membrane 40 and a distal portion 52 of the membrane 40, in which:
the upper frame 10 comprises a supply channel 65 for supplying a first electrochemical fluid and an inlet channel 60 for the first fluid supplying a lateral face of the first electrode 20, the inlet channel 60 comprising an orifice 62 in the distal portion 12 of the upper frame 10 opening onto a lateral face of the first electrode 20,
the upper frame 10 comprises a discharge channel 85 for discharging the first electrochemical fluid and a discharge channel 80 for discharging the first fluid through a lateral face of the electrode 20, 30, the discharge channel 80 comprising an orifice 82 in the distal portion 12 opening onto a lateral face of the first electrode 20,
the lower frame 50 comprises a supply channel 66 for supplying a second electrochemical fluid and an inlet channel 61 for the second fluid supplying a lateral face of the second electrode 30, the inlet channel 61 comprising an orifice 63 in the distal portion 52 of the lower frame 50 opening onto a lateral face of the second electrode 30,
the lower frame 50 comprises a discharge channel 86 for discharging the second electrochemical fluid and a discharge channel 81 for discharging the second fluid through a lateral face of the second electrode 30, the discharge channel 81 comprising an orifice 83 in the distal portion 52 opening onto a lateral face of the second electrode 30,
at least one, and preferably both, of the inlet channel 60 and outlet channel 80 of the upper frame 10 and the inlet channel 61 and the outlet channel 81 of the upper frame 50, comprises an inlet orifice 64, 67, respectively outlet orifice 84, 87, respectively, opening onto the supply channel 65, respectively discharge channel 85, in the proximal portion 14, 54 of the frame 10, 50.

The invention also relates to a method for making such cells comprising positioning a first electrode 20 in an orifice housing an electrode 13 of an upper frame 10 as defined above, positioning a second electrode 30 in an orifice housing an electrode 53 in the lower frame 50 as defined above, positioning a sealing gasket 15 in a gasket housing 11 of the upper frame 10, positioning a sealing gasket 55 in a gasket housing 51 of the lower frame 50, positioning a membrane 40 opposite the inner sealing gaskets 15, 55, positioning the upper frame 10 opposite the lower frame 50 in inner sealed closing of the membrane 40.

The invention also relates to a method comprising the implementation of an electrochemical cell as defined according to the present invention or a stack as defined according to the present invention.

The invention will be described more precisely in connection with the figures, without limitation of the scope of the invention.

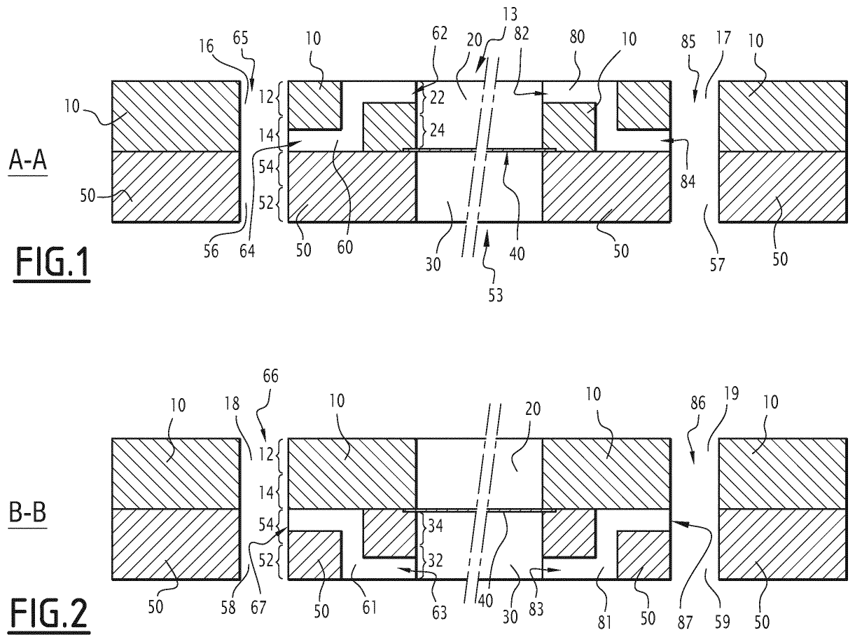

FIG. 1 shows a diagram of a section along axis AA of a cell according to one embodiment of the present invention at a channel for supplying 65 and discharging 85 a fluid of the first electrode 20.

FIG. 2 shows a diagram of a section along axis BB of a cell according to one embodiment of the present invention at a channel for supplying 66 and discharging 86 a fluid of the second electrode 30.

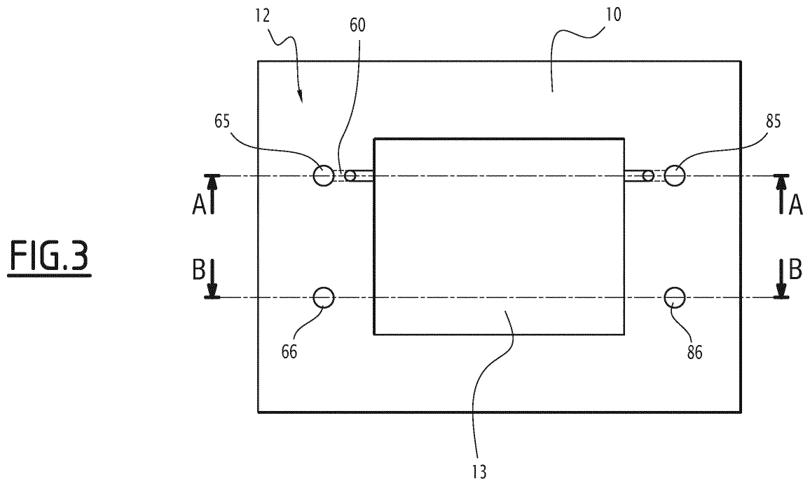

FIG. 3 shows a diagram in top view of a frame according to one embodiment of the present invention and showing axes AA and BB of the sections of FIGS. 1 and 2.

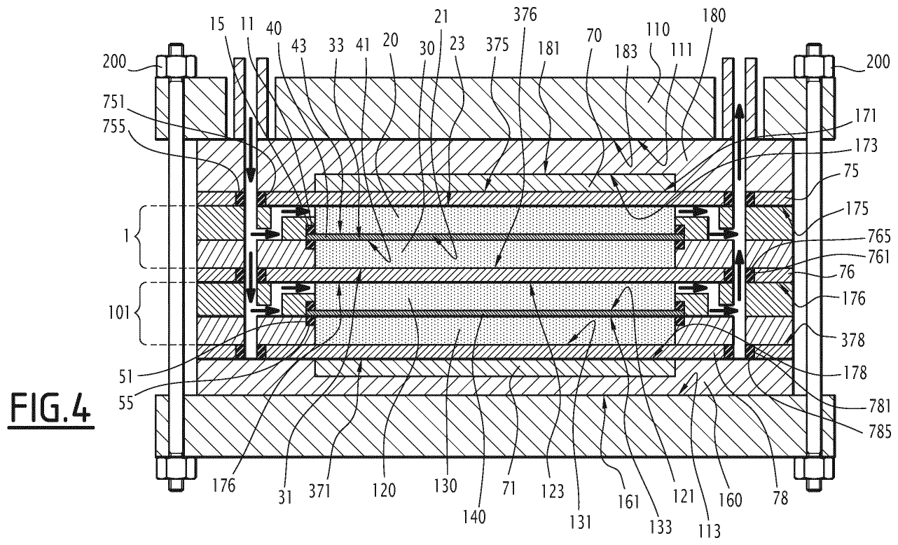

FIG. 4 shows a section in a plane passing through the longitudinal axis of the supply channel and the longitudinal axis of the discharge channel for the first electrochemical fluid by a stack according to one embodiment of the invention.

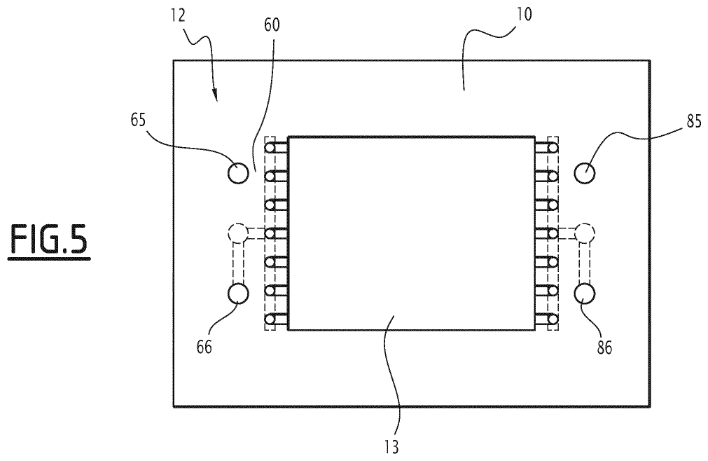

FIG. 5 shows a diagram of a top view of a frame with a fluid distribution mode in which the supply and discharge channels are reduced to distribute the supply and discharge of the fluid over the electrodes.

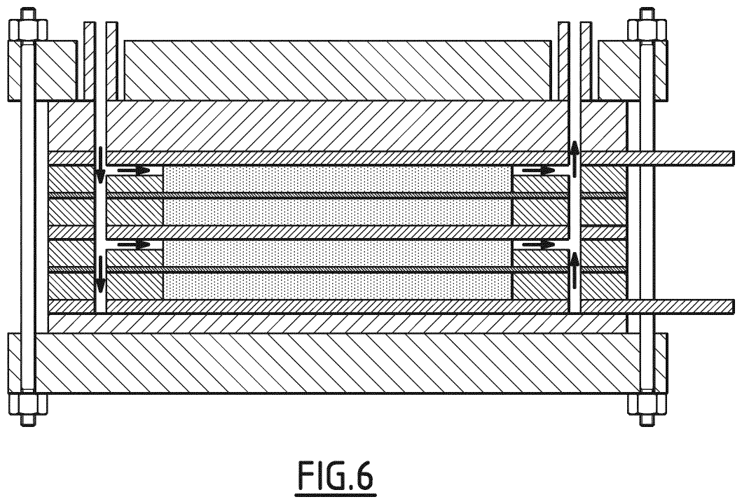

FIG. 6 shows a diagram of a section of a stack according to the prior art.

In the present invention, reference is made independently to the different elements by their reference number in the figures, with no limitation on the scope of the invention. The references to an element with several reference numbers indicate that the description generally applies to the element bearing the sign to which reference is made. Thus for example, a reference to the electrode 20, 30 means that the description generally and independently applies to the electrode 20 and the electrode 30.

Advantageously, the first electrode 20 is intended to receive a first electrochemical fluid.

Advantageously, the second electrode 30 is intended to receive a second electrochemical fluid.

The first and second electrochemical fluids may be identical or different.

The contact of the electrode 20, 30 with the membrane 40 may be direct or indirect. Thus, according to one embodiment, the electrode 20, 30 is in contact with the membrane 40 with no intermediate element. According to another embodiment, the electrode 20, 30 is in indirect contact with the membrane 40, separated by an intermediate element.

Advantageously, the upper frame 10 comprises a housing 11 for a sealing gasket 15 and the lower frame 50 comprises a housing 51 for a sealing gasket 55, the sealing gaskets 15, 55 being in contact with the membrane 40.

Typically, the first electrode 20 is in direct contact with the membrane 40 and the second electrode 30 is in direct contact with the membrane 40. Thus, typically the membrane 40 is in contact by a surface with the first electrode 20 and by an opposite surface with the second electrode 30.

The frame 10, 50 in general comprises at least a first through hole 16, 56 (respectively) preferably transverse, perpendicular to its largest dimension, forming part of a first supply channel 65 for a first electrochemical fluid.

Advantageously, the frame 10, 50 comprises at least a second through hole 17, 57 (respectively) preferably transverse, perpendicular to its largest dimension, forming part of the first discharge channel 85 for the first electrochemical fluid, and in general positioned opposite the first supply channel 65.

The frame 10, 50 in general comprises at least a third through hole 18, 58 (respectively) preferably transverse, perpendicular to its largest dimension, forming part of a second supply channel 66 for a second electrochemical fluid.

Advantageously, the frame 10, 50 comprises at least a fourth through hole 19, 59 (respectively) preferably transverse, perpendicular to its largest dimension, forming part of the second discharge channel 86 for the second electrochemical fluid, and in general positioned opposite the second supply channel 66.

According to one alternative, the frame 10 comprises several supply 65, 66 and discharge 85, 86 channels for electric chemical fluids. These channels are known from the prior art and for example used to supply different electrochemical fluids to the electrodes of an electrochemical cell.

The first supply channel 65 is intended to supply a first electrochemical fluid to the first electrode 20. The first discharge channel 85 is intended to discharge the first electrochemical fluid from the first electrode 20.

The second supply channel 66 is intended to supply a second electrochemical fluid to the second electrode 30. The second discharge channel 86 is intended to discharge the second electrochemical fluid from the second electrode 30.

The inlet channel 60 for the fluid emerging on the first electrode 20 is typically in fluid communication with the supply channel 65 to allow the supply of the first electrochemical fluid for the first electrode 20.

The outlet channel 80 for the fluid emerging on the first electrode 20 is typically in fluid communication with the discharge channel 85 to allow the discharge of the first electrochemical fluid from the first electrode 20.

The second inlet channel 61 for the fluid emerging on the second electrode 30 is typically in fluid communication with the supply channel 66 to allow the supply of the second electrochemical fluid for the second electrode 30.

The second outlet channel 81 for the fluid emerging on the second electrode 30 is typically in fluid communication with the second discharge channel 86 to allow the discharge of the second electrochemical fluid for the second electrode 30.

Advantageously, the inlet 60, 61 and outlet 80, 81 channels have a length providing a sufficient electrical resistance to limit the shunt currents. The inlet 60, 61 and outlet 80, 81 channels must not be too long so that the head loss is not too great. One skilled in the art therefore seeks a compromise in this respect. As an example, the inlet 60, 61 and outlet 80, 81 channels have a length of about 1 to 500 millimeters.

The orifice 62, 63 in the distal portion 12, 52 emerges on a distal portion 22, 32 of the lateral face of the electrode 20, 30 and constitutes a supply outlet orifice for the fluid of the channel 60, 61.

The orifice 82, 83 in the distal portion 12, 52 emerges on a distal portion 22, 32 of the lateral face of the electrode 20, 30 and constitutes a discharge inlet orifice for the fluid of the channel 80, 81.

The orifice 64, 67 in the proximal portion 14, 54 emerges on the supply channel 65, 66 and constitutes a supply inlet orifice for the fluid of the channel 60, 61.

The orifice 84, 87 in the proximal portion 14, 54 emerges on the discharge channel 85, 86 and constitutes a discharge outlet orifice for the fluid of the channel 80, 81.

In order to decrease the contact zone between the electrochemical fluid and the intercalary plate, which may cause a shunt current, the electrochemical fluid is sent into the frame 10, 50 by the proximal portion 14, 54, then passes through the frame 10, 50 in the distal portion 12, 52 in order to supply the electrode 20, 30. According to one alternative, the electrochemical fluid circulating in the proximal portion is at least partly or entirely in contact with the 2 frames 10, 50. According to one alternative, the electrochemical fluid circulating in the distal portion is at least partly or entirely in contact with the frame and the intercalary plate. The invention advantageously makes it possible to technically functionalize the frame(s) 10, 50 with a supply 60, 61 and/or discharge 80, 81 pipe having a configuration limiting the shunt currents (proximal portion configuration) and a configuration optimizing the fluid distribution in the cells 20, 30 (distal portion configuration).

The configuration making it possible to limit the shunt currents according to the present invention defines a shunt channel. The length and the section of the shunt channel depend on the conductivity of the electrochemical fluids and the cell stack (therefore the voltage of the stack). The greater the stack is, the stronger the shunt currents are, therefore the more the electrical resistance between cells must be increased. In other words, the longer the shunt channel must be and/or the smaller the section of the channel must be. The counterpart is an increased head loss of the stack. A compromise must therefore be struck between minimizing the shunt currents and minimizing the consumption of the pumps. A compromise must also be found regarding the maximum number of cells to be stacked.

According to one embodiment, the frame 10, 50 comprises a homogeneous distribution system for the first electrochemical fluid and/or the second electrochemical fluid respectively in the first electrode 20 and/or the second electrode 30.

According to one embodiment, at least one, and preferably all, of the inlet orifice 64 of the supply channel 60, the outlet orifice 84 of the discharge channel 80 of the upper frame 10, the inlet orifice 67 of the supply channel 61, and the outlet orifice 87 of the discharge channel 81 of the lower frame 50, emerge(s) on the proximal portion 12, 52 of the opposite frame 10, 50.

“Opposite frame” refers to the lower frame 50 in reference to the upper frame 10 and the upper frame 10 in reference to the lower frame 50.

Thus, according to one variant, when the orifice in the frame emerges on an opposite frame, a product is formed by combining the two frames.

Advantageously, the inlet orifice of the supply channel and outlet orifice of the discharge channel emerge on the frame and thus form a supply channel inlet 60, 61 and a discharge channel outlet 80, 81 by combination of the upper 10 and lower 20 frames.

According to one embodiment, at least one, and preferably all, of the outlet orifice 62 of the supply channel 60, the inlet orifice 82 of the discharge channel 80 of the upper frame 10, the orifice 63 of the supply channel 61, and the inlet orifice 83 of the discharge channel 81 of the lower frame 50, emerge(s) on the surface of an intercalary plate 70, 76, 78.

In reference to FIG. 5, the supply channel 65, 66 and/or the discharge channel 85, 86 may comprise a bypass, for example in the form of an elbow, in the proximal portion 14, 54 making it possible to shift the supply and/or discharge orifice, respectively, preferably toward the center of the lateral face of the electrodes 20, 30 and to emerge in the distal portion 12, 52 on a multitude of supply and/or outlet channels, respectively so as to distribute the supply fluid as homogeneously as possible on the lateral face of the electrodes 20, 30, in their distal portion 22, 32. Such supplies may have a so-called rake shape. It is preferred for the length of the channel in the proximal portion 14, 54 to be as long as possible, since it participates directly in increasing the inter-cell electrical resistance, therefore increases the shunt, and for that in the distal portion 12, 52 to be as short as possible, since it does not participate in the shunt.

According to one embodiment, the upper frame 10 and the lower frame 50 are symmetrical and interchangeable. Thus, a single and same frame can form both the upper frame 10 and the lower frame 50 by simple reversal.

In general, the frames are made from thermoplastic polymer, for example polyvinyl chloride (PVC).

A frame is generally molded or machined and can also be printed, for example by three-dimensional printing.

According to one embodiment, the first electrode 20, the second electrode 30 and the membrane 40 are kept in contact by pressure.

The contact by pressure is contact on at least a portion of the electrodes. Due to their substantially identical or similar dimensions, according to one embodiment, the membrane 40, the first electrode 20 and the second electrode 30 have a substantially identical or similar area, with the area of the membrane not taking into account the porosity of the membrane. Thus, advantageously, the contact surface is made up of the surface of the second electrode 30.

According to one embodiment, the frames are kept secured by contact pressure.

The upper frame 10 and the lower frame 50 are securely kept in contact.

According to one advantageous variant, the upper frame 10 and the lower frame 50 are securely kept in contact by gluing or welding. For example, it is possible to heat seal the lower face of the upper frame 10 with the upper face of the lower frame 50. To heat seal the frames, it is possible to use a polymer film (for example polyethylene terephthalate (PET), polyethylene naphthalate (PEN), Mylar®, etc.). Heat sealing advantageously makes it possible to close the shunt channel when it emerges in the proximal part on an opposite frame and thus to add an additional electrical resistance to the shunt channel. The membrane 40 is advantageously captured between the two frames 10, 50.

According to one embodiment, the membrane 40 is positioned in contact with the frame 10, 50, and in particular in contact at least at one point with the sealing gasket 15, 55.

The membrane 40 has an upper surface 43 and a lower surface 41, 43, the upper surface being in contact with the first electrode 20 and the lower surface 41 being in contact with the second electrode 30.

Advantageously, the membrane 40 has a periphery substantially identical or similar to the periphery of the membrane 40 sealing gasket(s) 15, 55.

The periphery of the membrane 40 can be in contact with the inner sealing gasket(s) 15, 55 of the membrane. Thus, the membrane can have a smaller size that optimizes the active surface of the membrane relative to its total surface and decreases the production costs. For example, the pressure to keep the electrodes in contact with the membrane and optionally the other elements of an electrochemical cell makes it possible to “pinch” the periphery of the membrane 40 between the inner sealing gaskets 15, 55.

For example, the membrane is an ion exchange permeable membrane. For example, the membrane is an ion exchange membrane comprising an organic polymer, and preferably a halogenated organic polymer, and still more preferably a fluorinated polymer. Such preferred polymers are known and commercially available, for example such as Nafion®.

The sealing gasket 15, 55 makes it possible to avoid an electrochemical fluid leak coming from the first electrode 20 toward the second electrode 30, or vice versa, without passing through the membrane 40. Thus, the sealing gasket 15, 55 prevents the fluid bypass of the membrane 40.

The sealing gasket 15, 55 housing 11, 51 advantageously forms a receiving groove of the sealing gasket 15, 55.

According to one variant, the housing 11, 51 forms a recess made in the frame 10, 50 able to receive an annular sealing gasket 15, 55.

The frame 10, 50 may comprise several gasket 15, 55 housings 11, 51.

The sealing gasket 15, 55 provides the inner sealing between the membrane 40 and the frame 10, 50 respectively in order to prevent a fluid flow, of the electrochemical fluid type, outside the contact zone of the membrane 40 with the electrodes 20, 30.

The frame 10, 50 advantageously comprises one or several sealing gaskets, not shown, providing the outer sealing of the fluid circulation in the supply channel and/or the discharge channel at the distal portion 12, 52 of the frame 10, 50.

The frame 10, 50 advantageously comprises one or several sealing gaskets, not shown, providing the outer sealing of the fluid circulation in the supply channel and/or the discharge channel at the proximal portion 14, 54 of the frame 10, 50.

The gaskets providing the inner sealing prevent any contact between the anode zone and the cathode zone. The gaskets providing the outer sealing prevent any contact with the ambient atmosphere and the leaks of electrochemical fluids toward the outside of the cell.

Typically, the electrode 20, 30 is a porous electrode. Such an electrode is intended to receive an electrochemical fluid in its porosity.

According to one variant, the porous electrode is a porous carbon electrode, typically made up of a carbon felt or graphite felt. Such electrodes are known in the field of redox-flow electrochemical cells. Typically, such an electrode of a graphite felt has a thickness of 3 to 12 mm when it is not compressed and 2 to 6 mm when it is compressed, thus providing good electrical contact with a current collector plate.

According to one variant, the first electrode 20 and the second electrode 30 have a substantially identical or similar thickness.

According to one variant, the first electrode 20 has a width and/or a length that are substantially identical or similar to the width and/or the length, respectively, of the second electrode 30.

According to one variant, the first electrode 20 has a surface substantially identical or similar to the surface of the second electrode 30.

According to one variant, the surface of the first electrode 20 and/or the second electrode 30 is substantially identical or similar to the surface of the membrane 40.

Typically, the first electrode 20 is in contact with the upper frame 10 by these outer edges, so as to be positioned edge to edge in the housing 13 of the upper frame 10.

Advantageously, the first electrode 20 is in contact with the orifice 62 of the supply channel 60 and the orifice 82 of the discharge channel 80.

Typically, the second electrode 30 is in contact with the lower frame 50 by these outer edges, so as to be positioned edge to edge in the housing 53 of the lower frame 50.

Advantageously, the second electrode 30 is in contact with the orifice 63 of the supply channel 61 and the orifice 83 of the discharge channel 81.

The invention also relates to a stack 100 of several electrochemical cells comprising several stacked electrochemical cells 1, 101, as described according to the invention.

Advantageously, the stack of frames and intercalary plates forms a channel.

Preferably, the stack of electrochemical cells, and in particular the stack of first supply holes 16, 56 and second discharge holes 17, 57, respectively forms a first supply channel 65 for a first electrochemical fluid and a first discharge channel 85 for a first electrochemical fluid, said first electrochemical fluid being contained in the first electrode 20. Preferably, the stack of electrochemical cells 1, 101, and in particular the stack of third supply holes 18, 58 and fourth discharge holes 19, 59, respectively forms a second supply channel 66 for a second electrochemical fluid and a second discharge channel 86 for a second electrochemical fluid, said second electrochemical fluid being contained in the second electrode 30.

The supply channels 65 and 66 and the discharge channels 85 and 86 can each be independently in fluid communication with storage or refill reservoirs respectively for a first electrochemical fluid for example containing one or several electrolytes and a second electrochemical fluid for example containing one or several electrolytes, the first and second electrochemical fluids being able to contain identical or different chemical species, in particular electrolytes.

According to one embodiment:
the upper surface 23 of the first electrode 20 of a first electrochemical cell 1 is in contact with the lower surface 175 of a first intercalary plate 75, forming a reactive electrode (where the electrochemical reaction takes place);
the lower surface 31 of the second electrode 30 of a first electrochemical cell 1 is in contact with the upper surface 376 of a second intercalary plate 76, forming a reactive electrode (where the electrochemical reaction takes place);
the upper surface 123 of the first electrode 120 of a second electrochemical cell 101 is in contact with the lower surface 176 of a second intercalary plate 76;
the lower surface 131 of the second electrode 130 of a second electrochemical cell 101 is in contact with the upper surface 378 of a first intercalary plate 78, forming a reactive electrode (where the electrochemical reaction takes place);
the lower surface 178 of the last intercalary plate 78 is in contact with the upper surface 363 of a reactive forming plate 71 (where the electrochemical reaction takes place);
the upper surface 375 of the first intercalary plate 75 is in contact with the lower surface 171 of an electric current collector plate 70.

Typically, the supply plate 180 is in contact by its lower surface 181 with the upper surface 173 of a first collector plate 70 and by its upper surface 183 with the lower surface 111 of a flange 110.

Typically, the closing plate 160 is in contact by its lower surface 161 with the upper surface 113 of a flange 200.

Advantageously, the stack forms a flow-redox battery (2).

According to one variant, the stack comprises at least two electrochemical cells.

According to one variant, the stack comprises at least twenty electrochemical cells.

According to one variant, the stack comprises at least fifty electrochemical cells.

Advantageously, the electrochemical cell according the invention comprises a current collector plate 70 in direct contact with an electrode 20, 30.

Typically, the current collector plates are made up of or comprise a conductive element, for example a metal element, optionally in alloy form, and/or a graphite or a composite material comprising graphite. In general, this is a good conductor element, typically copper.

The intermediate current collector plates 75, 76, 78 are generally bipolar collector plates.

The intermediate current collector plates 75, 76, 78 are advantageously electrically isolated from the fluid circulating in the supply and discharge channels by gaskets 751, 761, 781 respectively positioned in gasket grooves 755, 765, 785.

The supply plate 180 in particular makes it possible to bring the fluids to the stack, and to isolate the collector plates 70 electrically from the clamping flanges 110 tightened with (metal) nuts 200 and advantageously makes it possible to embed a collector plate therein supplying the current for the stack. The closing plate 160 performs the same functions by embedding a collector plate 71 of the current of the stack and contains the fluid channels 65, 66, 85, 86 of the stack.

For example, the maintenance of the first 20 and second 30 electrodes in contact is provided by a clamping flange 110 of the frame.

Typically, a clamping flange 110 keeps a stack of electrochemical cells and current collector plates in compression.

The present invention is in particular applicable to the field of electrochemical cells, and more particularly relates to redox-flow electrochemical cells.

The present invention also relates to fuel cells comprising cells according to the invention. The present invention further relates to electrolytic cells.

1-10. (canceled)

11. A frame (10, 50) of a porous electrochemical cell electrode (20, 30), said electrode being intended to make contact with a membrane (40), wherein:
said frame (10, 50) comprises a proximal portion (14, 54) close to a membrane (40), and a distal portion (12, 52) distant from the membrane (40)
said frame (10, 50) comprises a supply channel (65, 66) supplying an electrochemical fluid and an inlet channel (60, 61) for a fluid supplying a lateral face of the electrode (20, 30), the inlet channel (60, 61) comprising an orifice (62, 63) in the distal portion (12, 52) opening onto a lateral face of the electrode (20, 30),
said frame (10, 50) comprises a discharge channel (85, 86) discharging an electrochemical fluid and an outlet channel (80, 81) through which the fluid exits via a lateral face of the electrode (20, 30), the outlet channel (80, 81) comprising an orifice (82, 83) in the distal portion (12, 52) opening onto a lateral face of the electrode (20, 30),
at least one of the inlet channel (60, 61) and outlet channel (80, 81) comprises an inlet orifice (64, 67) or outlet orifice (84, 87), respectively, opening onto a supply channel (65, 66) or discharge channel (85, 86), respectively, in the proximal portion (14, 54) of the frame (10).

12. An electrochemical cell (1) comprising at least one frame according to claim 11, said cell comprising an upper frame (10) housing a first electrode (20) and a lower frame (50) housing a second electrode (30), the first electrode (20) and the second electrode (30) being separated from one another by a membrane (40), the first electrode (20) facing the membrane (40) by its lower face and the second electrode (30) facing the membrane (40) by its upper face, the upper frame (10) comprising a proximal portion (14) of the membrane (40) and a distal portion (12) of the membrane (40), the lower frame (50) comprising a proximal portion (54) of the membrane (40) and a distal portion (52) of the membrane (40), wherein:
said upper frame (10) comprises a supply channel (65) supplying a first electrochemical fluid and an inlet channel (60) for the first fluid supplying a lateral face of the first electrode (20), the inlet channel (60) comprising an orifice (62) in the distal portion (12) of the upper frame (10) opening onto a lateral face of the first electrode (20),
said upper frame (10) comprises a discharge channel (85) discharging the first electrochemical fluid and a discharge channel (80) discharging the first fluid through a lateral face of the electrode (20, 30), the discharge channel (80) comprising an orifice (82) in the distal portion (12) opening onto a lateral face of the first electrode (20),
the lower frame (50) comprises a supply channel (66) supplying a second electrochemical fluid and an inlet channel (61) for the second fluid supplying a lateral face of the second electrode (30), the inlet channel (61) comprising an orifice (63) in the distal portion (52) of the lower frame (50) opening onto a lateral face of the second electrode (30),
the lower frame (50) comprises a discharge channel (86) discharging the second electrochemical fluid and a discharge channel (81) discharging the second fluid through a lateral face of the second electrode (30), the discharge channel (81) comprising an orifice (83) in the distal portion (52) opening onto a lateral face of the second electrode (30),
at least one, of the inlet channel (60) and outlet channel (80) of the upper frame (10) and the inlet channel (61) and the outlet channel (81) of the upper frame (50), comprises an inlet orifice (64, 67), respectively outlet orifice (84, 87), respectively, opening onto the supply channel (65), respectively discharge channel (85), in the proximal portion (14, 54) of the frame (10, 50).

13. The electrochemical cell (1) according to claim 12, wherein said upper frame (10) comprises a housing (11) for a sealing gasket (15) and the lower frame (50) comprises a housing (51) for a sealing gasket (55), the sealing gaskets (15, 55) being in contact with the membrane (40).

14. The electrochemical cell (1) according to claim 12, wherein said frame (10, 50) comprises a homogeneous distribution system for the first electrochemical fluid and/or the second electrochemical fluid respectively in the first electrode (20) and/or the second electrode (30).

15. The electrochemical cell (1) according to claim 12, wherein at least one of the inlet orifice (64) of the supply channel (60), the outlet orifice (84) of the discharge channel (80) of the upper frame (10), the inlet orifice (67) of the supply channel (61), and the outlet orifice (87) of the discharge channel (81) of the lower frame (50), emerge(s) on the proximal portion (12, 52) of the opposite frame (10, 50).

16. The electrochemical cell (1) according to claim 12, wherein at least one of the outlet orifice (62) of the supply channel (60), the inlet orifice (82) of the discharge channel (80) of the upper frame (10), the orifice (63) of the supply channel (61), and the inlet orifice (83) of the discharge channel (81) of the lower frame (50), emerge(s) on the surface of an intercalary plate (70, 76, 78).

17. The electrochemical cell (1) according to claim 12, wherein said membrane (40) has a periphery substantially identical or similar to the periphery of the membrane (40) sealing gasket(s) (15, 55).

18. A stack (100) of several electrochemical cells, wherein said stack comprises several electrochemical cells (1, 101), defined according to claim 12, stacked.

19. A method for producing electricity, comprising the implementation of an electrochemical cell as defined according to claim 12.

20. A method for making an electrochemical cell, said method comprising:
positioning a first electrode (20) in an orifice housing an electrode (13) of an upper frame (10);
positioning a second electrode (30) in an orifice housing an electrode (53) in the lower frame (50),
wherein the upper frame (10) houses the first electrode (20) and the lower frame (50) houses the second electrode (30), the first electrode (20) and the second electrode (30) being separated from one another by a membrane (40), the first electrode (20) facing the membrane (40) by its lower face and the second electrode (30) facing the membrane (40) by its upper face, the upper frame (10) comprising a proximal portion (14) of the membrane (40) and a distal portion (12) of the membrane (40), the lower frame (50) comprising a proximal portion (54) of the membrane (40) and a distal portion (52) of the membrane (40), and wherein:
said upper frame (10) comprises a supply channel (65) supplying a first electrochemical fluid and an inlet channel (60) for the first fluid supplying a lateral face of the first electrode (20), the inlet channel (60) comprising an orifice (62) in the distal portion (12) of the upper frame (10) opening onto a lateral face of the first electrode (20),
said upper frame (10) comprises a discharge channel (85) discharging the first electrochemical fluid and a discharge channel (80) discharging the first fluid through a lateral face of the electrode (20, 30), the discharge channel (80) comprising an orifice (82) in the distal portion (12) opening onto a lateral face of the first electrode (20),
the lower frame (50) comprises a supply channel (66) supplying a second electrochemical fluid and an inlet channel (61) for the second fluid supplying a lateral face of the second electrode (30), the inlet channel (61) comprising an orifice (63) in the distal portion (52) of the lower frame (50) opening onto a lateral face of the second electrode (30),
the lower frame (50) comprises a discharge channel (86) discharging the second electrochemical fluid and a discharge channel (81) discharging the second fluid through a lateral face of the second electrode (30), the discharge channel (81) comprising an orifice (83) in the distal portion (52) opening onto a lateral face of the second electrode (30),
at least one, of the inlet channel (60) and outlet channel (80) of the upper frame (10) and the inlet channel (61) and the outlet channel (81) of the upper frame (50), comprises an inlet orifice (64, 67), respectively outlet orifice (84, 87), respectively, opening onto the supply channel (65), respectively discharge channel (85), in the proximal portion (14, 54) of the frame (10, 50);
positioning a sealing gasket (15) in a gasket housing (11) of the upper frame (10), positioning a sealing gasket (55) in a gasket housing (51) of the lower frame (50), positioning a membrane (40) opposite the inner sealing gaskets (15, 55), positioning the upper frame (10) opposite the lower frame (50) in inner sealed closing of the membrane (40).

21. A method for producing electricity, comprising the implementation of a stack as defined according to claim 20.
